(19) United States
(12) Patent Application Publication
(10) Pub. No.: US 2011/0165307 A1
(43) Pub. Date: Jul. 7, 2011

(54) REDUCED CALORIE SWEETENED ACIDIC BEVERAGES WITH NUTRITIVE SWEETENER

(76) Inventors: Hubert Denis, Brussels (BE); Sabine Lecocq, Manage (BE)

(21) Appl. No.: 13/061,542

(22) PCT Filed: Sep. 4, 2009
(86) PCT No.: PCT/US09/56017

§ 371 Date: Mar. 1, 2011

Related U.S. Application Data
(60) Provisional application No. 61/095,490, filed on Sep. 9, 2008.

(51) Int. Cl. A23L 2/60

(52) U.S. Cl. 426/590

(57) ABSTRACT

A beverage comprising at least one nutritive sweetener and art add combination comprising at least a first acid and a second acid is provided. The acid combination increases sweetness of the beverage, reduces sourness of the beverage, increases intensity of a flavor of the beverage, improves mouthfeel of the beverage, or combinations thereof as compared to the beverage without, the acid combination and comprising an equivalent molar amount of citric acid. Certain embodiments of the present invention provide a reduced calorie beverage devoid of high intensive sweeteners.

### TECHNICAL FIELD

This invention generally relates to beverages sweetened with a nutritive sweetener.

### BACKGROUND OF THE INVENTION

Traditionally, beverages may include nutritive sweeteners such as sucrose, dextrose, fructose, and isoglucose. Though these sweeteners may provide the most suitable taste to the consumers and synergies between these sweeteners exist, they may also provide calories. For example, the synergy between sucrose and fructose may be used to decrease the total nutritive content and the caloric content of a beverage without substantially affecting the sensory performance of the beverage. The decrease may not be substantial enough, however, to allow for labeling of the beverage as “reduced calorie” under some government regulations. Typically, beverages with decreased caloric context may include high intensive sweeteners (i.e., high intensity sweeteners, high potency sweeteners). However, some consumers prefer beverage without high intensity sweeteners.

Accordingly, there is a need for beverages which avoid one or more of the aforementioned disadvantages and deficiencies provide improved tasting, reduced calorie sweetened beverages.

### SUMMARY OF THE INVENTION

The present disclosure encompasses a beverage comprising at least one nutritive sweetener and an acid combination comprising at least a first acid and a second acid. The acid combination increases sweetness of the beverage, reduces sourness of the beverage, increases intensity of a flavor of the beverage, improves mouthfeel of the beverage, or combinations thereof as compared to the beverage without the acid combination and comprising an equivalent molar amount of citric acid. The first acid may comprise tartaric acid and the second acid may comprise an acid selected from the group comprising lactic acid, phosphoric acid, malic acid, fumaric acid, or combinations thereof.

Other objects, features, and advantages of this invention will be apparent from the following detailed description and claims.

### DETAILED DESCRIPTION OF THE EMBODIMENTS

As summarized above, this disclosure encompasses beverages comprising at least one nutritive sweetener and an acid combination. Embodiments of the beverages of the present invention use as nutritive sweetener and an acid combination to improve beverage attributes, such as sweetness, sourness, flavor, and mouthfeel, in reduced calorie beverages.

As used herein, the term “increases sweetness of the beverage” may include, but is not limited to enhancing or intensifying the perception of the sweet taste of the beverage.

As used herein, the term “increases intensity of a flavor of the beverage” may include, but is not limited to improving the sensory profile of the beverage.

As used herein, “mouthfeel” refers to the overall body, texture, fullness of flavor, richness of flavor, viscosity sensation, tactile sensation, or similar attributes of the beverage.

As used herein, “beverage” refers to the fluid or liquid suitable for human consumption wherein the beverage of the present invention may include water, flavored water, flavored beverages, carbonated water, syrup, diet beverages, carbonated soft drinks, fruit juices, fruit containing beverages, fruit flavored beverages, vegetable juices, vegetable containing beverages, isotonic beverages, non-isotonic beverages, soft drinks containing a fruit juice, coffee, tea, dairy products, soy products, and combinations thereof. According to particular embodiments of the present invention, the beverage can comprise beverage formulations already in use to provide well-known or familiarly flavored drinks, such as cola, diet cola, lemon-lime, orange, orange juice, beer, tea or tea-flavored drinks, and root beer, for example.

In some embodiments, the beverages include nutritive sweeteners that are refined or semi-refined carbohydrates. “Nutritive sweeteners” as used herein may include, but are not limited to, fructose, dextrose, sucrose, saccharose, partially or totally inverted sugar, starch derivates produced by partial or total hydrolysis where the hydrolysates may be isomerized by enzymatic treatment, or the like. In particular embodiments, the beverages may include at least two nutritive sweeteners. In certain embodiments, the beverage may be devoid of nutritive sweeteners.

In certain embodiments, at least one nutritive sweetener may be present in an amount ranging from about 1 weight % to about 20 weight % of the beverage. In other embodiments, the nutritive sweetener may be present in an amount ranging from about 2 weight % to about 8 weight % or about 2 weight % to about 15 weight % of the beverage. In other embodiments, the nutritive sweetener may be present in an amount ranging from about 5 weight % to about 12 weight % of the beverage. For example, an embodiment comprising flavored water as the beverage may include at: least one nutritive sweetener in an amount of about 2 weight % of the beverage while another embodiment comprising a carbonated soft drink as the beverage may include at least one nutritive sweetener in an amount of about 12 weight % of the beverage.

In certain embodiments, the beverage may comprise at least two nutritive sweeteners such as sucrose and fructose. In such an embodiment, the sucrose to fructose ratio may range from about 2:3 to about 9:1. Thus, in such an embodiment, sucrose may be present in an amount ranging from about 40 weight % to about 90 weight % of the total nutritive sweeteners in the beverage, or more particularly ranging from about 50 weight % and about 80 weight % of the total nutritive sweeteners in the beverage. In a specific embodiment, the sucrose concentration in the beverage may be about 3.75 weight % of the beverage and the fructose concentration may be about 1.25 weight % of the beverage. Thus, the total calorie content of the beverage may be reduced by about 50% based on a referenced full calorie beverage that includes sucrose in an amount of about 11 weight % of the beverage.

In certain embodiments, the beverage may have a Brix of about 8 or less. In other embodiments, the beverage may have as Brix ranging from about 8 to about 3. In still other embodiments, the beverage may have a Brix ranging from about 8 to about 5.

In certain embodiments, the beverage may comprise about 90 calories per about 330 mL serving or less. In other embodiments, the beverage may comprise from about 15 calories to about 160 calories per about 330 mL serving. In still other embodiments, the beverage may comprise from about 75 calories to about 110 calorie per about 330 mL serving.

Thus, in particular embodiments, a beverage comprising about 90 calories per about 330 mL serving may provide a 40% calorie reduction, a beverage comprising about 90 calories per about 290 mL serving may provide a 30% calorie reduction, and a beverage comprising about 90 calories per about 390 mL serving may provide a 50% calorie reduction, in other embodiments, a flavored water beverage comprising about 15 calories per about 300 mL serving may provide a 50% calorie reduction, a carbonated soft drink comprising about 75 calories per about 330 mL serving may provide a 50% calorie reduction, and a carbonated soft drink comprising about 110 calories per about 330 mL serving may provide a 30% calorie reduction.

Embodiments of the beverages also include an acid combination comprising at least a first acid and a second acid. In certain embodiments, the acid combination may comprise two acids selected from the group consisting of tartaric acid, phosphoric acid, lactic acid, malic acid, and fumaric acid. In some embodiments, the first acid may comprise tartaric acid and the second acid may comprise lactic acid, phosphoric acid, malic acid, or fumaric acid. In other embodiments, the first acid may comprise tartaric acid and the second acid may comprise phosphoric acid.

In certain embodiments, the total amount of the first acid and the second acid present in the beverage may range from about 20 ppm to about 10,000 ppm. In other embodiments, the total amount of the first acid and the second acid present in the beverage may range from about 50 ppm to about 2,000 ppm. The beverages may also be present in a range from about 20 ppm to about 2,000 ppm or about 50 ppm to about 10,000 ppm.

In alternate embodiments, the total amount of the first acid and the second acid may be based on their sourness equivalence as compared to acid (e.g., citric acid) in a reference beverage.

In particular embodiments where the first acid or the second acid comprises tartaric acid, the tartaric acid may be present in the beverage in an amount ranging from about 20 ppm to about 10,000 ppm. In other embodiments, where the first acid or the second acid comprises tartaric acid, the tartaric acid may be present in the beverage in an amount ranging from about 100 ppm to about 2000 ppm.

In other embodiments, where the first acid or the second acid comprises phosphoric acid, the phosphoric acid may be present in the beverage in an amount ranging from about 10 ppm to about 1000 ppm. In other embodiments, where the first acid or the second acid comprises phosphoric acid, the phosphoric acid may be present in the beverage in an amount ranging from about 50 ppm to about 500 ppm.

In certain embodiments, where the first acid or the second acid comprises lactic acid, the lactic acid may be present in the beverage in an amount ranging from about 20 ppm to about 4000 ppm. In certain embodiments, where the first acid or the second acid comprises lactic acid, the lactic acid may be present in the beverage in an amount ranging from about 100 ppm to about 2000 ppm.

In other embodiments, the beverages of the present invention ma y also include at least one buffer. In particular embodiments, the buffer may comprise a salt of the first acid and/or second acid. In some embodiments, the buffer may comprise a phosphate salt or a lactate salt. Suitable examples of buffers include, but are not limited to trisodium citrate, di sodium hydrogenophosphate, sodium dihydrogen phosphate, sodium gluconate, calcium lactate, di sodium fumarate, monosodium fumarate, and combinations thereof. In certain embodiments, the buffer may be added to achieve a target pH of the beverage.

In certain embodiments, the buffer may be present in the beverage in an amount from about 20 ppm to about 1,000 ppm. In other embodiments, the total amount of the buffer present in the beverage may range from about 40 ppm to about 800 ppm.

Embodiments of the beverages of the present invention may also include flavorants and flavoring ingredients. Suitable flavorants and flavoring, ingredients include, but are not limited to, sweetness enhancers. “Sweetness enhancers” are flavors which are designed to improve the sweetness perception of the end beverages. In particular embodiments, the sweetness enhancer may be present in the beverage may range from about 50 ppm to about 500 ppm. In other embodiments, the sweetness enhancer may be present in the beverage in an amount from about 100 ppm to about 400 ppm.

Embodiments of the beverages of the present invention may also include minerals. In certain embodiments, minerals included in the beverages may have molecular weights ranging from about 50 to about 500 g/mole. Examples of suitable minerals include, but are not limited to, potassium chloride, magnesium sulfate, or a combination of thereof. For instance, in one embodiment, the beverage may include about 50 ppm potassium chloride and about 460 ppm magnesium sulphate heptahydrate. Other suitable minerals include, bit are not limited to calcium lactate pentahydrate and sodium chloride.

In particular embodiments, the minerals may be present in the beverage in an amount from about 20 ppm to about 2,000 ppm. In other embodiments, the minerals may be present in the beverage in an amount from about 50 ppm to about 1000 ppm.

In certain embodiments, the beverage may include sodium phosphate, carbonation, and juice while comprising an acidic pH. In particular embodiments, the beverage may also comprise additional acids, stabilizers, thickeners, preservatives, coloring, carbonated water, additives, SHMP, or combinations thereof. Preservatives of the beverage may comprise sodium benzoate, potassium sorbate, or combinations thereof.

It should be understood by a person of ordinary skill in the art that the beverages may be made by any method suitable for making beverages.

Without being bound by theory, it is believed that the beverage of the present invention may provide reduced calorie beverages with no added high intensity sweeteners yet still provide pleasing attributes as compared to a beverage without the acid combination that comprises an equivalent molar amount of citric acid. Embodiments of the beverage may provide improved sensory attributes as compared to a beverage comprising only citric acid. In particular, the combination of the first acid and the second acid are believed, to provide at least a synergistic effect, if not an improved overall sensory experience.

While food acids have generally been used to provide a pleasant, refreshing acidic taste to foods, drinks and beverages, they have also been utilized as a preservation aid by lowering the pH of the foodstuff to which they are added to reduce the activity of possible harmful micro-organisms. Commonly, citric acid has been used for this purpose. The benefits of the present invention, however, provide advantageous sensory results over the use of citric acid alone or in combination. Due to the large quantity of organic acids presently available, the inventors have discovered that there is no simple substitute for one organic acid for another and thus, introduce the inventive combination of acids that provide desirable sensory profiles, particularly for a reduced-calorie beverage. For example, a reduced-calorie beverage (calories are reduced by 30%-50%) comprising the acid combination of the present invention has a pleasingly and comparable synergistic sensory profile of its full-calorie, similarly flavored beverage. Other acid combinations, particularly citric acid, tend to change the profile such that the taste of the reduced-calorie and full-calorie are drastically distinguishable. While this may be preferred by some consumers, the idea of the present invention is to be able to offer a reduced-calorie beverage with a comparable and synergistic sensory profile of its full-calorie beverage. The particular elements of the present invention makes this possible, particularly the nutritive sweetener in combination with a particular first and second acid.

Other embodiments are further illustrated below in the examples which are not to be construed in any way as imposing limitations upon the scope of this disclosure. On the contrary, it is to be clearly understood that resort may be had to various other embodiments, modifications, and equivalents thereof which after reading the description therein, may suggest themselves to those skilled in the all without departing from the scope of this disclosure and the appended claims.

### EXAMPLES

### Example 1

Beverages are exemplified in accordance with embodiments of the present invention (shown as “Ex.”) having the formulations detailed in Tables 1-3. The beverages were made and compared to a full calorie reference beverage (shown as “C”.). The results of the comparison are included in Tables 1-3.

TABLE 1
Carbonated Beverage #1

| Sample | C. 1 | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Calorie reduction | 0% | 40% | 40% | 40% | 40% | 40% | 40% | 40% | 40% |
| | ppm | ppm | ppm | ppm | ppm | ppm | ppm | ppm | ppm |
| Citric acid | 2000 | 1130 | 905 | 905 | 0 | 0 | 0 | 0 | 0 |
| Lactic acid (88%) | 0 | 0 | 310 | 0 | 0 | 0 | 770 | 0 | 0 |
| Malic acid | 0 | 0 | 0 | 0 | 510 | 0 | 0 | 0 | 0 |
| Phosphoric acid (75%) | 0 | 0 | 0 | 175 | 0 | 245 | 0 | 245 | 120 |
| Tartaric acid | 0 | 0 | 0 | 0 | 480 | 840 | 480 | 480 | 480 |
| Tri sodium Citrate | 110 | 60 | 50 | 60 | 0 | 0 | 0 | 0 | 0 |
| Calcium Lactate penta | 0 | 0 | 0 | 0 | 0 | 0 | 115 | 0 | 0 |
| hydrate | | | | | | | | | |
| Sodium hydrogen | 0 | 0 | 0 | 0 | 0 | 505 | 0 | 505 | 250 |
| phosphate | | | | | | | | | |

Based on the above table, those acid combinations which showed favorable sensory results (i.e. “Good”) were Ex. 6-8 compared to the low scoring samples comprising citric acid alone or in combination.

TABLE 2
Carbonated Beverage #2

| Sample | C. 2 | Ex. 9 | Ex. 10 | Ex. 11 | Ex. 12 | Ex. 13 | Ex. 14 | Ex. 15 |
|---|---|---|---|---|---|---|---|---|
| Calorie reduction | 0% | 50% | 50% | 50% | 50% | 50% | 50% | 50% |
| | ppm | ppm | ppm | ppm | ppm | ppm | ppm | ppm |
| Citric acid | 2000 | 945 | 310 | 310 | 0 | 0 | 0 | 0 |
| Glucono delta lactone | 0 | 0 | 880 | 1765 | 880 | 1765 | 0 | 0 |
| Lactic acid (88%) | 0 | 0 | 0 | 0 | 0 | 0 | 640 | 0 |
| Phosphoric acid (75%) | 0 | 0 | 0 | 0 | 0 | 0 | 0 | 100-205 |
| Tartaric acid | 0 | 0 | 265 | 265 | 265 | 265 | 400 | 400 |
| Tri sodium Citrate | 110 | 50 | 20 | 20 | 0 | 0 | 0 | 0 |
| Sodium gluconate | 0 | 0 | 120 | 240 | 120 | 240 | 0 | 0 |
| Calcium Lactate penta | 0 | 0 | 0 | 0 | 0 | 0 | 100 | 0 |
| hydrate | | | | | | | | |
| Sodium hydrogen | 0 | 0 | 0 | 0 | 0 | 0 | 0 | 210-420 |
| phosphate | | | | | | | | |

Based on the above table, Ex. 14 and 15 showed favorable sensory results (i.e. “Good”) while Ex. 10-13 showed no improvement.

TABLE 3
Carbonated Beverage #3

| Sample name | C. 3 | Ex. 16 | Ex. 17 | Ex. 18 | Ex. 19 |
|---|---|---|---|---|---|
| Calorie reduction | 0% | 40% | 40% | 40% | 40% |
| | ppm | ppm | ppm | ppm | ppm |
| Citric acid | 2300 | 1380 | 0 | 0 | 0 |
| Lactic acid (88%) | 0 | 0 | 940 | 0 | 0 |
| Phosphoric acid (75%) | 0 | 0 | 0 | 230 | 230 |
| Tartaric acid | 0 | 0 | 590 | 730 | 590 |
| Tri sodium Citrate | 115 | 70 | 0 | 0 | 0 |
| Calcium Lactate penta | 0 | 0 | 140 | 0 | 0 |
| hydrate | | | | | |
| Sodium hydrogen | 0 | 0 | 0 | 235 | 235 |
| phosphate | | | | | |

Based on the above table, Ex. 17 and 19 showed favorable sensory results (i.e. “Good”) compared to the other samples.
As shown above in Tables 1-3, the first and second acid comprising lactic acid, phosphoric and tartaric acid in the varying combinations shown demonstrated favorable sensory taste profiles in comparison to the use of citric acid alone or in combination.

### Example 2

Additional beverages in accordance with embodiments of the present invention were made having the formulations detailed in Tables 4-6. Table 4 shows the reference beverage comprising citric acid. Table 5 shows a full-calorie beverage of the present invention via Ex. A-B. Table 6 shows 30% reduced-calorie beverages of the present invention via. Ex. C-F.

TABLE 4
REFERENCE BEVERAGE

| Ingredient | % | g (grams) |
|---|---|---|
| Potassium sorbate | 0.020 | 0.200 |
| Citric acid | 0.200 | 2.000 |
| anhydrous | | |
| Lactic acid | 0.000 | 0.000 |
| Phosphoric acid | 0.000 | 0.000 |
| Tartaric acid | 0.000 | 0.000 |
| Fumaric acid | 0.000 | 0.000 |
| Na₃Citrate2H₂O | 0.018 | 0.018 |
| NaH₂PO₄ | 0.000 | 0.000 |
| Orange flavor | 1.405 | 14.048 |
| Sugar | 7.200 | 72.000 |
| Fructose | 3.400 | 34.000 |
| Water Total | 87.76 | 877.58 |
| Total | 100.00 | 1000.00 |
| K Cal/100 g | — | 45.99 |
| Sugars/100 g | — | 11.02 |
| % Cal reduction | — | — |
| % Sugars reduction | — | — |

TABLE 5

| | EX. A | | EX. B | |
|---|---|---|---|---|
| Ingredient | % | (g) | % | (g) |
| Potassium sorbate | 0.020 | 0.200 | 0.020 | 0.200 |
| Citric acid | 0.00 | 0.00 | 0.00 | 0.00 |
| anhydrous | | | | |
| Lactic acid | 0.00 | 0.00 | 0.136 | 1.364 |
| Phosphoric acid | 0.022 | 0.222 | 0.00 | 0.00 |
| Tartaric acid | 0.850 | 0.850 | 0.850 | 0.850 |
| Fumaric acid | 0.00 | 0.00 | 0.00 | 0.00 |
| Na₃Citrate2H₂O | 0.00 | 0.00 | 0.00 | 0.00 |
| Ca(Lactate)₂•5H₂O | 0.00 | 0.00 | 0.020 | 0.205 |
| NaH₂PO₄ | 0.046 | 0.456 | 0.00 | 0.00 |
| Orange flavor | 1.405 | 14.048 | 1.405 | 14.048 |
| Sugar | 7.200 | 72.00 | 7.20 | 72.00 |
| Fructose | 3.400 | 34.00 | 3.400 | 34.00 |
| Water Total | 87.82 | 878.22 | 87.73 | 877.33 |
| Total | 100.00 | 1000.00 | 100.00 | 1000.00 |
| K Cal/100 g | — | 45.47 | — | 46.00 |
| Sugars/100 g | — | 11.020 | — | 11.02 |
| % Cal reduction | — | — | — | — |
| % Sugars reduction | — | — | — | — |

TABLE 6

| | EX. C | | Ex. D | | Ex. E | | EX. F | |
|---|---|---|---|---|---|---|---|---|
| Ingredient | % | (g) | % | (g) | % | (g) | % | (g) |
| Potassium sorbate | 0.020 | 0.200 | 0.02 | 0.20 | 0.020 | 0.200 | 0.02 | 0.20 |
| Citric acid | 0.00 | 0.00 | 0.00 | 0.00 | 0.140 | 1.400 | 0.00 | 0.00 |
| anhydrous | | | | | | | | |
| Lactic acid | 0.096 | 0.955 | 0.00 | 0.00 | 0.00 | 0.00 | 0.00 | 0.00 |
| Phosphoric acid | 0.00 | 0.00 | 0.00 | 0.00 | 0.00 | 0.00 | 0.016 | 0.155 |
| Tartaric acid | 0.060 | 0.590 | 0.00 | 0.00 | 0.00 | 0.00 | 0.060 | 0.595 |
| Fumaric acid | 0.00 | 0.00 | 0.0790 | 0.790 | 0.00 | 0.00 | 0.00 | 0.00 |
| Na₃Citrate2H₂O | 0.00 | 0.00 | 0.00 | 0.00 | 0.012 | 0.123 | 0.00 | 0.00 |
| Ca(Lactate)₂•5H₂O | 0.014 | 0.144 | 0.00 | 0.00 | 0.00 | 0.00 | 0.00 | 0.00 |
| NaH₂PO₄ | 0.00 | 0.00 | 0.00 | 0.00 | 0.00 | 0.00 | 0.032 | 0.319 |
| Orange flavor | 1.405 | 14.048 | 1.405 | 14.048 | 1.405 | 14.048 | 1.405 | 14.048 |
| Sugar | 5.04 | 50.400 | 5.04 | 50.40 | 5.040 | 50.40 | 5.04 | 50.40 |
| Fructose | 2.380 | 23.80 | 2.38 | 23.80 | 2.38 | 23.80 | 2.38 | 23.80 |
| Water Total | 90.99 | 909.86 | 91.06 | 910.62 | 91.00 | 910.03 | 91.05 | 910.48 |
| Total | 100.00 | 1000.00 | 100.00 | 1000.00 | 100.00 | 1000.00 | 100.00 | 1000.00 |
| K Cal/100 g | — | 33.02 | — | 32.72 | — | 33.01 | — | 32.64 |
| Sugars/100 g | — | 7.84 | — | 7.84 | — | 7.840 | — | 7.84 |
| % Cal reduction | — | 27.40 | — | 28.80 | — | 28.200 | — | 28.20 |
| % Sugars reduction | — | 28.90 | — | 28.90 | — | 28.90 | — | 28.90 |

A panel of tasters evaluated the beverages having the formulations in Tables 4-6 in paired tests. The panelists were asked to evaluate the attributes of each beverage according to intensity, sweetness, sourness and bitterness. The results of the comparison are included in Tables 8-11 indicating (+), (−), or “no difference” as the perception of the compared attributes noticed by the tasters.

It should be noted that the significance in differences evaluated by the panelists are indicated in Table 7 and should be used as a legend to read Tables 8-11.

TABLE 7

| Legend Indicator | Significance with α |
|---|---|
| *** | 0.001 |
| ** | 0.01 |
| * | 0.05 |
| ° | 0.1 |

TABLE 8

| | | |
|---|---|---|
| | paired test 1 | |
| products | EX. C v. EX. D | significance |

| | | | |
|---|---|---|---|
| Intensity | + | − | 0.0428* |
| Sweet | − | (+) | 0.0987° |

| | | |
|---|---|---|
| Sour | No differences | 0.2005 |
| Bitter | No differences | >0.9999 |

TABLE 9

| | | |
|---|---|---|
| | paired test 2 | |
| products | EX. F v. EX. D | significance |

| | | | |
|---|---|---|---|
| Intensity | − | (+) | 0.0987° |
| Sweet | + | − | 0.0161* |
| Sour | − | + | 0.0161* |

| | | |
|---|---|---|
| Bitter | No differences | 0.5847 |

TABLE 10

| | paired test 3 | |
|---|---|---|
| products | EX. C v. EX. E | significance |
| Intensity | No differences | 0.8555 |
| Sweet | No differences | 0.3616 |
| Sour | No differences | 0.3616 |
| Bitter | No differences | 0.3616 |

TABLE 11

| | paired test 4 | |
|---|---|---|
| products | EX. F v. EX. E | significance |
| Intensity | No differences | 0.5847 |

| | | | |
|---|---|---|---|
| Sweet | ++ | − | 0.0052** |
| Sour | − | + | 0.0161* |
| Bitter | − | + | 0.0428* |

As shown above, the present invention shows comparable results in the paired tests and indicates positive attributes of significant sweetness which is usually not attributed to the addition of citric acid within a beverage. The present invention provides a reduced calorie beverage with the sweetness profile of a full-calorie beverage that is surprisingly pleasing to consumers desiring such calorie reduction. Due to the elements of the present invention, consumers are able to enjoy the aesthetic qualities of a full-calorie beverage while benefiting from reduction of calories.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

We claim:

1. A beverage comprising:
at least one nutritive sweetener; and
an acid combination comprising at least a first acid and a second acid, wherein the acid combination increases sweetness of the beverage, reduces sourness of the beverage, increases intensity of a flavor of the beverage, improves mouthfeel of the beverage, or combinations thereof as compared to the beverage without the acid combination and comprising an equivalent molar amount of citric acid.

2. A beverage comprising:
at least one nutritive sweetener; and
an acid combination comprising at least a first acid and a second acid, wherein the first acid comprises tartaric acid, and wherein the second acid comprises lactic acid, phosphoric acid, or fumaric acid.

3. The beverage of claim 2, wherein the beverage is devoid of high intensity sweeteners.

4. The beverage of claim 2, wherein the beverage has a Brix of about 8 or less.

5. The beverage of claim 2, wherein the beverage comprises about 110 calories per 330 mL serving or less.

6. The beverage of claim 2, wherein the at least one nutritive sweetener is present in the beverage in an amount ranging from about 1 weight % to about 20 weight % of the beverage.

7. The beverage of claim 2, wherein the tartaric acid in the beverage is present in an amount ranging from about 20 ppm to about 10,000 ppm.

8. The beverage of claim 2, wherein the second acid comprises phosphoric acid in an amount ranging from about 10 ppm to about 1,000 ppm of the beverage.

9. The beverage of claim 2, wherein the at least one nutritive sweetener comprises at least two nutritive sweeteners.

10. The beverage of claim 10, wherein the at least two nutritive sweeteners comprises fructose and sucrose.

11. The beverage of claim 11, wherein the weight ratio of sucrose to fructose ranges from about 2:3 to about 9:1.

12. The beverage of claim 2, further comprising at least one buffer.

13. The beverage of claim 13, wherein the at least one buffer comprises a phosphate salt or a lactate salt.

14. The beverage of claim 14, wherein the at least one buffer is present in the beverage in an amount ranging from about 20 ppm to about 1,000 ppm.

15. The beverage of claim 2, further comprising at least one sweetness enhancer.

16. The beverage of claim 16, wherein the at least one sweetness enhancer is present in the beverage in an amount ranging from about 50 ppm to about 500 ppm.
